(19) United States
(12) Patent Application Publication
(10) Pub. No.: US 2023/0351179 A1
(43) Pub. Date: Nov. 2, 2023

(54) LEARNING APPARATUS FOR USE IN HIDING PROCESS USING NEURAL NETWORK, INFERENCE APPARATUS, INFERENCE SYSTEM, CONTROL METHOD FOR THE LEARNING APPARATUS, CONTROL METHOD FOR THE INFERENCE APPARATUS, AND PROGRAM

(71) Applicant: CANON KABUSHIKI KAISHA, Tokyo (JP)

(72) Inventor: Akihiro TANABE, Tokyo (JP)

(21) Appl. No.: 18/297,670

(22) Filed: Apr. 10, 2023

(30) Foreign Application Priority Data
Apr. 28, 2022 (JP) 2022-075014

(51) Int. Cl. G06N 3/08; G06N 5/04

(52) U.S. Cl. CPC G06N 3/08; G06N 5/04

(57) ABSTRACT

A learning apparatus which is capable of implementing a hiding process even if there is no processing unit exclusively for hiding. The learning apparatus is used for the hiding process using a neural network. Output data is obtained from a first inference model that has been trained and performs predetermined processing on input data. A second inference model that includes a processing layer for hiding, which includes at least one layer for hiding the output data is obtained. The output data from the first inference model is used as input data to train the second inference model.

### BACKGROUND OF THE INVENTION

### Field of the Invention

The present invention relates to a learning apparatus, an inference apparatus, an inference system, a control method for the learning apparatus, a control method for the inference apparatus, and a program.

### Description of the Related Art

Deep learning techniques using neural networks are applied in a wide range of technical fields, and in particular, it is said that classification in which images are recognized and classified has surpassed human cognitive abilities.

A convolutional neural network (CNN), which is especially widely used, implements highly-accurate deep learning by recurrently applying convolution to an image.

In recent years, due to the popularity of SNS (Social Networking Service) or the like, security has been a growing concern for data such as images. The reason is that, for example, in services that share data such as SNS, data communication from an edge terminal to a cloud server is necessary, and for privacy protection, it is common to hide data in communication.

Neural networks have been used for such security measures as well, and for example, a method in which an image in data is hidden by image conversion is known. However, a hiding method using a simple neural network that performs the same processing any type of input images cannot always meet user's demands for hiding images.

Accordingly, Japanese Laid-Open Patent Publication (Kokai) No. 2019-125128 discloses a technique in which a user selects a hiding model from a plurality of hiding patterns according to the type of an images to be hidden, and the image to be hidden is hidden by the selected hiding model so that its confidentiality can be enhanced.

However, the user of the technique disclosed in Japanese Laid-Open Patent Publication (Kokai) No. 2019-125128 requires an additional encryption processing unit for hiding. For example, when encryption is processed by hardware, it is necessary to additionally prepare a circuit that functions as an encryption unit, and when encryption is processed by software, it is necessary to additionally prepare a control unit that functions as an encryption unit.

### SUMMARY OF THE INVENTION

The present invention provides a learning apparatus, an inference apparatus, an inference system, a control method for the learning apparatus, a control method for the inference apparatus, which implement a hiding process even if there is no processing unit exclusively for hiding, as well as a program.

According to an aspect of the invention, the present invention provides a learning apparatus for use in a hiding process using a neural network, comprising at least one processor configured to perform operations of obtaining output data from a first inference model that has been trained and performs predetermined processing on input data, obtaining a second inference model including a processing layer for hiding comprising at least one layer for hiding the output data, and using the output data from the first inference model as input data to train the second inference model.

According to an aspect of the invention, the present invention provides an inference apparatus for use in a hiding process using a neural network, comprising at least one processor configured to perform operations of executing a first inference model that has been trained and performs predetermined processing on input data, and obtaining output data from the first inference model, obtaining a second inference model that has been trained and includes a processing layer for hiding comprising at least one layer for hiding the output data, and using the output data from the first inference model as input data to run the second inference model and outputting output data from the second inference model as an inference result.

According to an aspect of the invention, the present invention provides an inference system for use in a hiding process using a neural network, comprising a learning apparatus, a first inference apparatus, and a second inference apparatus, wherein the learning apparatus comprises at least one processor configured to perform operations of obtaining output data from a first inference model that has been trained and performs predetermined processing on input data, obtaining a second inference model including a processing layer for hiding comprising at least one layer for hiding the output data, using the output data from the first inference model as input data to train the second inference model, obtaining a third inference model including a processing layer for decryption comprising at least one layer for decrypting output data from the second inference model, and using the output data from the second inference model as input data and using the output data from the first inference model as training data to train the third inference model, wherein the first inference apparatus comprises at least one processor configured to perform operations of running a first inference model that has been trained and performs predetermined processing on input data, and obtaining output data from the first inference model, obtaining the trained second inference model from the learning apparatus, using the obtained output data from the first inference model as input data to run the obtained second inference model and outputting output data from the second inference model, and sending the output data from the second inference model to the second inference apparatus, wherein the second inference apparatus comprises at least one processor configured to perform operations of receiving the output data from the second inference model from the first inference apparatus, obtaining the trained third inference model from the learning apparatus, and using the output data received from the second inference model as input data to run the obtained third inference model and decrypting the output data from the second inference model.

According to the present invention, a hiding process can be implemented even if there is no processing unit exclusively for hiding.

Further features of the present invention will become apparent from the following description of exemplary embodiments (with reference to the attached drawings).

### BRIEF DESCRIPTION OF THE DRAWINGS

FIG. 1 is a diagram showing an example of a system configuration of an inference system according to a first embodiment, which is intended for hiding and decryption and includes an information processing apparatus, a learning apparatus, and an inference apparatus.

FIG. 2 is a diagram illustrating a block configuration of the learning apparatus in FIG. 1.

FIG. 3 is a diagram illustrating a block configuration of the inference apparatus in FIG. 1.

FIG. 4 is a view illustrating the flow of data in a learning process according to the first embodiment, which is carried out by the learning apparatus in FIG. 1.

FIGS. 5A and 5B are flowcharts illustrating a learning process for a hiding model and a learning process for a decryption model, respectively, according to the first embodiment, which are carried out by the learning apparatus.

FIG. 6 is a flowchart illustrating an inference process according to the first embodiment, which is carried out by the inference apparatus.

FIG. 7 is a flowchart illustrating a decryption process according to the first embodiment, which is carried out by the information processing apparatus.

FIG. 8 is a view illustrating the flow of data in a learning process according to a second embodiment, which is carried out by the learning apparatus.

FIG. 9 is a flowchart illustrating a learning process for a hiding/decryption model according to the second embodiment, which is carried out by the learning apparatus.

### DESCRIPTION OF THE EMBODIMENTS

The present invention will now be described in detail below with reference to the accompanying drawings showing embodiments thereof.

### First Embodiment

### Configuration

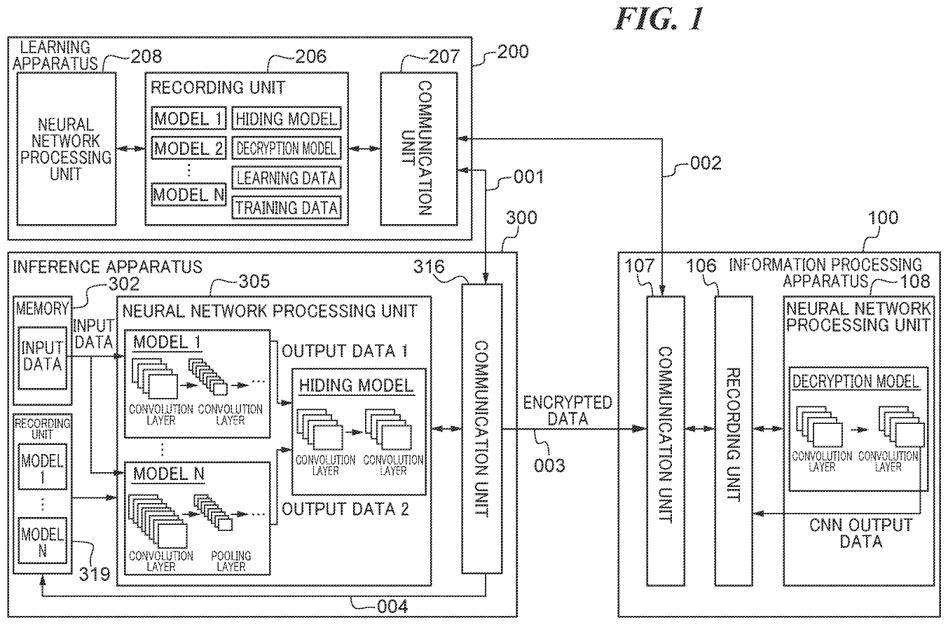

FIG. 1 is a diagram showing an example of a system configuration of an inference system according to a first embodiment of the present invention, which is intended for encryption and decryption and includes an information processing apparatus 100, a learning apparatus 200, and an inference apparatus 300.

It should be noted that the information processing apparatus 100, the learning apparatus 200, and the inference apparatus 300 are connected to one another via their respective communication units. Here, each of the communication units is comprised of Wi-Fi (IEEE802.11 Standard), which is wireless communication, a wired LAN (Local Area Network), which is wired communication, a USB (Universal Serial Bus), or the like.

A communication path 001 connects the learning apparatus 200 and the inference apparatus 300 together, a communication path 002 connects the information processing apparatus 100 and the learning apparatus 200 together, and a communication path 003 connects the inference apparatus 300 and the information processing apparatus 100 together. It should be noted that although in the first embodiment, the information processing apparatus 100 and the learning apparatus 200 are described as different apparatuses, they can be the same apparatus. The information processing apparatus 100 and the learning apparatus 200 have the same configuration. Specifically, a communication unit 107 and a communication unit 207 have the same configuration, a recording unit 106 and a recording unit 206 have the same configuration, and a neural network processing unit 108 and a neural network processing unit 208 have the same configuration.

The learning apparatus 200 trains and generates a hiding model and a decryption model. Data such as models 1 to N (existing models), learning data, and training data are recorded in the recording unit 206 of the learning apparatus 200. The neural network processing unit 208 performs learning using these data to generate the hiding model and the decryption model. The generated hiding model is sent to the inference apparatus 300 via the communication path 001, and the generated decryption model is sent to the information processing apparatus 100 via the communication path 002.

It should be noted that the models 1 to N according to the present invention are network models that perform predetermined processing on input data by performing neural network processing. In the first embodiment, CNNs (Convolutional Neural Network) including nonlinear processing layers such as convolutional layers and fully-connected layers) are used for the models 1 to N. The present invention, however, is not limited to this, but the models 1 to N may be other network models such as DNN, RNN/LSTM, and GAN. A program in which the details of neural network processing are described, and learned factor parameters such as a weighting factor and bias are stored in the models 1 to N. It should be noted that the weighting factor is a value for representing the strength of connection between nodes in a neural network, and the bias is a value for applying an offset to the sum of the weighting factor and input data.

The inference apparatus 300 (first inference apparatus) records the hiding model, which has been received from the learning apparatus 200 by a communication unit 316, in a recording unit 319. The inference apparatus 300 runs a desired model among the models 1 to N using input data held in a memory 320 and obtains output data from the desired model. When hiding is necessary, the inference apparatus 300 obtains the hiding model from the recording unit 319, inputs the output data from the desired model to the hiding model in the recording unit 319, and obtains a hidden output result. The communication unit 316 of the inference apparatus 300 sends the hidden output result to the information processing apparatus 100 via the communication path 003.

The information processing apparatus 100 (second inference apparatus) records the decryption model, which has been received from the learning apparatus 200 by the communication unit 107, in the recording unit 106. The information processing apparatus 100 also receives the hidden output result from the recording unit 319 and holds the hidden output result in the recording unit 106. After that, the neural network processing unit 108 uses the hidden output result held in the recording unit 106 as input data and decrypts it by running the decryption model. The decrypted output result is recorded in the recording unit 106.

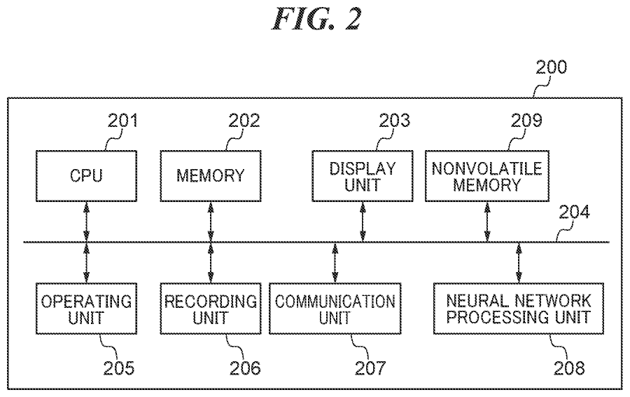

FIG. 2 is a diagram illustrating a block configuration of the learning apparatus 200 in FIG. 1.

As shown in FIG. 2, the learning apparatus 200 has a CPU 201, a memory 202, a display unit 203, an internal bus 204, an operating unit 205, the recording unit 206, the communication unit 207, the neural network processing unit 208, and a nonvolatile memory 209.

It should be noted that the block configuration of the information processing apparatus 100 in FIG. 1 is the same as that of the learning apparatus 200 described below. Thus, the third digits of numbers assigned to the components in the block configuration of the information processing apparatus 100 which correspond to the components in the block configuration of the learning apparatus 200 are “1”, and detailed description thereof is omitted. For example, the information processing apparatus 100 has a CPU 101 corresponding to the CPU 201.

The CPU 201 controls all of processing blocks constituting the learning apparatus 200 via the internal bus 204 by executing computer programs stored in the nonvolatile memory 209.

The memory 202 is a rewritable volatile memory. The memory 202 is used mainly as a work area for the CPU 201 and a temporary buffer area for data.

The display unit 203 is comprised of a liquid crystal panel, an organic EL panel, or the like, and displays operating screens and others in accordance with instructions from the CPU 201. The display unit 203 has, for example, an OSD (On Screen Display) function, which is a function of displaying setting screens such as a menu on the operating screens.

The internal bus 204 is a bus for connecting the processing blocks in the learning apparatus 200 to one another.

The operating unit 205 is comprised of a keyboard, a mouse, a button, a touch panel, a remote control, or the like, and provides a user interface for the user to operate the learning apparatus 200. Operational information input from the operating unit 205 is sent to the CPU 201, and the CPU 201 controls the processing blocks based on the operational information.

The recording unit 206 is comprised of a recording medium and stores and reads out various types of data in accordance with instructions from the CPU 201. Examples of the recording medium constituting the recording unit 206 include an EEPROM, internal flash memory, internal hard disk, and removable memory card. Input data and training data, which are data for learning to be used by the neural network processing unit 208, are stored in the recording unit 206.

The communication unit 207 has hardware or the like for carrying out communications using a wireless LAN or a wired LAN in accordance with instructions from the CPU 201. Specifically, to carry out communications using a wireless LAN, the communication unit 207 generates modulated signals conforming to a wireless communication standard such as IEEE 802.11n/a/g/b, outputs the modulated signals, and receives modulated signals from external devices. The communication unit 207 also connects to an external access point using a wireless LAN and communicates with wireless communication devices via the access point using the wireless LAN. The communication unit 207 is also capable of connecting to other devices via a wired LAN, which is connected to a wired cable, a USB, or the like. The communication unit 207 communicates with external devices, which include the inference apparatus 300 and the information processing apparatus 100, to exchange information such as images, control data, learning data, dictionary data, models, hiding model, and decryption model.

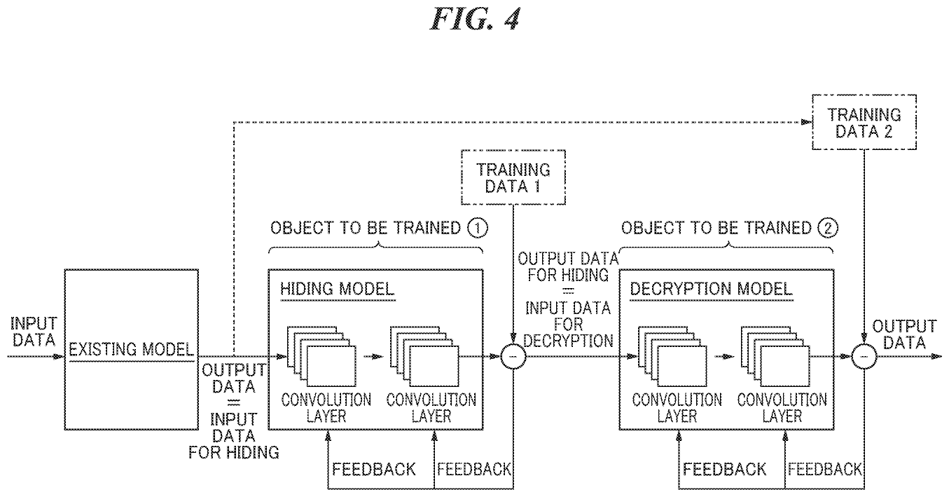

The neural network processing unit 208 carries out a learning process for a neural network using learning data, dictionary data, and a program in which the configuration of a model of the neural network created in advance is described, which are stored in the recording unit 206. The learning data, the dictionary data, and the model can be received through the communication unit 207, or those recorded in the recording unit 206 can be used. The neural network processing unit 208 is comprised of a GPU, a DSP (Digital Signal Processor), a TPU (Tensor Processing Unit), an NPU (Neural Network Processing Unit), or the like. It should be noted that the learning process for the neural network may be carried out by the CPU 201 without using the neural network processing unit 208 or may be carried out by both of them. A model (trained model) obtained as a result of the learning process carried out by the neural network processing unit 208 is also held in the recording unit 206. The neural network processing unit 208 is also able to carry out an inference process using the trained model stored in the recording unit 206 and input data for inference. It should be noted that how to learn the hiding model and the decryption model will be described in detail later with reference to FIG. 4.

The nonvolatile memory 209 is an electrically erasable/rewritable memory and is, for example, an EEPROM or a hard disk. The nonvolatile memory 209 stores computer programs for controlling the operation of the components in the learning apparatus 200 and information such as parameters relating to the operation of the components in the learning apparatus 200. The computer programs implement various types of operations performed by the learning apparatus 200. The nonvolatile memory 209 is also capable of holding the plurality of models, hiding model, and decryption model to be used by the neural network processing unit 208.

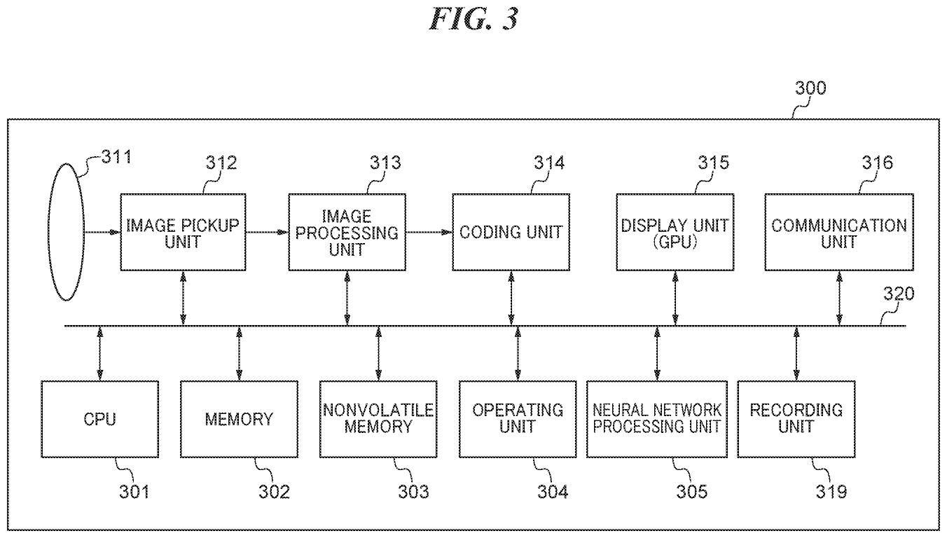

FIG. 3 is a diagram illustrating a block configuration of the inference apparatus 300 in FIG. 1.

As shown in FIG. 3, the inference apparatus 300 has a CPU 301, the memory 302, a nonvolatile memory 303, an operating unit 304, a neural network processing unit 305, the recording unit 319, a lens 311, an image pickup unit 312, an image processing unit 313, and a coding unit 314. The inference apparatus 300 has a display unit 315, the communication unit 316, and an internal bus 320.

The CPU 301 controls all of processing blocks constituting the inference apparatus 300 via the internal bus 320 by executing computer programs stored in the nonvolatile memory 303.

The memory 302 is a rewritable volatile memory. The memory 302 temporarily records computer programs for controlling the operation of the components in the inference apparatus 300, information such as parameters relating to the operation of the components in the inference apparatus 300, and the models and the hiding models received by the communication unit 316. The memory 302 also temporarily records images obtained by the image pickup unit 312 and images (input data) processed by the image processing unit 313, the coding unit 314, and the like, other information, and so forth. The memory 302 has a storage capacity enough to temporarily record them.

The nonvolatile memory 303 is an electrically erasable/rewritable memory and is, for example, an EEPROM or a hard disk. The nonvolatile memory 303 stores computer programs for controlling the operation of the components in the inference apparatus 300 and information such as parameters relating to the operation of the components in the inference apparatus 300. The computer programs implement various types of operations performed by the inference apparatus 300. The nonvolatile memory 303 is also capable of holding the plurality of models and the hiding models to be used by the neural network processing unit 305.

The operating unit 304 is comprised of a keyboard, a mouse, a button, a touch panel, a remote control, or the like, and provides a user interface for the user to operate the inference apparatus 300. Operational information input from the operating unit 304 is sent to the CPU 301, and the CPU 301 performs the processing blocks based on the operational information.

The neural network processing unit 305 inputs the input data stored in the memory 302 to a trained model created in advance such as the hiding model received from the learning apparatus 200 and carries out an inference process for a neural network. It should be noted that in the first embodiment, the CNN, the program in which the details of neural network processing are described, and the learned factor parameters such as the weight factor and the bias are stored in the trained model as described above, the present invention is not limited to this. Here, as for the learned factor parameters, weight factors and bias values, which edges connecting the nodes of layers have, are included in parameters for the fully-connected layer, and weight factors for kernel and bias are included in parameters for the convolutional layers. The neural network processing unit 305 also has a temporary storage area where the weight factors and the bias are temporarily stored. The neural network processing unit 305 also has a function of decoding compressed input data and learned factor parameters.

The recording unit 319 records the models 1 to N and other data in accordance with requests from the CPU 301. Examples of the recording unit 319 include a nonvolatile memory and a magnetic disk.

The lens (lens unit) 311 is comprised of a lens group including a zoom lens, a focus lens, and so forth, not shown, a lens control unit, not shown, a diaphragm, not shown, and so forth.

The image pickup unit 312 is an area image sensor comprised of a CCD (charge-coupled device), a CMOS (complementary metal oxide semiconductor), or the like and converts an optical image of a subject into an electric signal.

The image processing unit 313 performs predetermined image processing on image data output from the image pickup unit 312 or image data read out from the memory 302.

The coding unit 314 compresses image data by performing intra-frame predictive coding, inter-frame predictive coding, or the like on the image data.

The display unit 315 is comprised of a liquid crystal panel, an organic EL panel, or the like, and displays operating screens and others in accordance with instructions from the CPU 201. The display unit 315 has, for example, an OSD (On Screen Display) function, which is a function of displaying setting screens such as a menu on the operating screens.

The communication unit 316 has, for example, hardware for carrying out communications using a wireless LAN or a wired LAN in accordance with instructions from the CPU 301. Specifically, to carry out communications using a wireless LAN, the communication unit 316 generates modulated signals conforming to a wireless communication standard such as IEEE 802.11n/a/g/b, outputs the modulated signals, and receives modulated signals from external devices. The communication unit 316 also connects to an external access point using a wireless LAN and communicates with other wireless communication devices via the access point using the wireless LAN. The communication unit 316 is also capable of connecting to other devices via a wired LAN, which is connected to a wired cable, a USB, and the like. The communication unit 316 also communicates with external devices, which include the learning apparatus 200 and the information processing apparatus 100, to exchange information such as control signals of image signals. For example, the communication unit 316 can send image signals conforming to communication standards such as HDMI (registered trademark) (High-Definition Multimedia Interface) and SDI (Serial Digital Interface).

The internal bus 320 is a bus for connecting the processing blocks in the inference apparatus 300 to one another.

FIG. 4 is a view illustrating the flow of data in learning processes according to the first embodiment, which is carried out by the learning apparatus 200. It should be noted that the learning processes for the hiding model and the decryption model are carried out in the network processing unit 208 by the CPU 201 controlling programs for learning.

As shown in FIG. 4, in the learning apparatus 200, the learning process for the hiding model and the learning process for the decryption model are separately carried out.

First, a description will be given of the learning process for the hiding model. Here, the hiding model includes a processing layer for hiding, which is comprised of at least one layer (convolution layer in the first embodiment) for hiding output data from the existing model.

By inputting input data in the recording unit 206 to the existing model and subjecting the input data to predetermined neural network processing, output data is output. At this time, the output data form the existing model is used as input data (input data for hiding) for carrying out the learning process for the hiding model. Namely, when the output data from the existing model is input to the hiding model, pre-programmed neural network processing is performed on the hiding model. As a result, output data from the hiding model is obtained.

Next, the output data from the hiding model is compared with training data 1 prepared in advance in the recording unit 206, and based on the result of the comparison, feedback is given to each layer of the hiding model. As a result, parameters in each layer of the hiding model are optimized so as to make that the difference between the output data from the hiding model and the training data 1 small. The parameters in each layer of the hiding model are optimized using a learning algorithm for neural networks such as the back propagation method. It should be noted that the learning algorithm is a well-known technique and thus omitted from the description of the first embodiment. The training data 1 are values prepared in advance and do not include a certain number or more of zeros.

A description will now be given of the learning process for the decryption model. Here, the decryption model includes a processing layer for decryption, which is comprised of at least one layer (convolution layer in the first embodiment) for decrypting the output data from the hiding model and outputting data equivalent to the output data from the existing model.

Data output from the hiding model is used as input data (input data for decryption) for carrying out the learning process for the decryption model, and the output data from the existing model is used as training data 2. Namely, when the input data for decryption is input to the decryption model, pre-programmed neural network processing is performed on the decryption model. As a result, output data from the decryption model is obtained. Next, the output data from the decryption model is compared with the training data 2, and feedback is given to each layer of the decryption model. As a result, parameters in each layer of the decryption model are optimized so as to make that the difference between the output data from the decryption model and the training data 2 small. The decryption model is also optimized using a learning algorithm for neural networks such as the back propagation method as with the hiding model.

As a result of the training described above, data equivalent to the output data from the existing model can be output from the decryption model. It should be noted that although the hiding model and the decryption model are described as learning models of neural networks, other learning methods can be used. Moreover, although the learning process using the training data is described above, other learning methods such as reinforcement learning can be used.

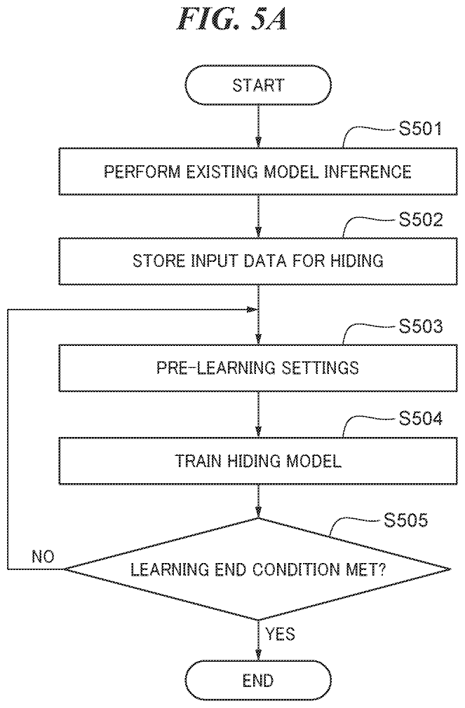

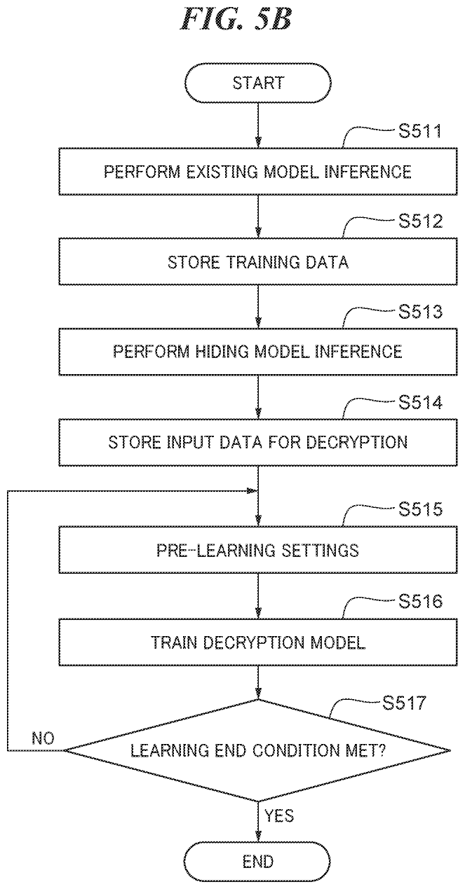

FIGS. 5A and 5B are flowcharts illustrating the learning process for the hiding model and the learning process for the decryption model, respectively, according to the first embodiment, which are carried out by the learning apparatus 200.

First, a description will be given of the flowchart in FIG. 5A illustrating the learning process for the hiding model, which is carried out by the learning apparatus 200. This learning process is implemented by a computer program stored in the recording unit 206 being loaded into the memory 202 and read out and executed by the CPU 201 when the power to the learning apparatus 200 is on.

In step S501, the CPU 201 carries out an inference process on an existing model (first inference model), which performs predetermined processing on input data through neural network processing. The CPU 201 selects a model, from which output data is desired to be hidden, from the plurality of existing models recorded in the recording unit 206 and loads input data in the recording unit 206 into the memory 202. Then, the neural network processing unit inputs the input data loaded into the memory 202 to the selected model and carries out the inference process on the selected model. Output data from the existing model obtained as a result of the inference process is held in the memory 202 by the CPU 201, and then the process proceeds to step S502. It should be noted that although in the first embodiment, the CPU 201 runs the existing model to obtain output data from it, the present invention is not limited to this as long as such output data can be obtained. For example, output data can be obtained from the inference apparatus 300. In this case, however, the security level of communication between the learning apparatus 200 and the inference apparatus 300 is required to be high.

In the step S502, the CPU 201 stores the output data obtained from the existing model, which was held in the memory 202 in the step S501, as input data for hiding in the recording unit 206, and then the process proceeds to step S503.

In the step S503, the CPU 201 obtains the hiding model (second inference model) from the nonvolatile memory 209 and makes pre-learning settings for the hiding model, followed by the process proceeding to step S504. Here, to make the pre-learning settings means setting hyperparameters such as the number of batches for use in learning, learning rate, and optimizer. It should be noted that the hyperparameters are diverse and setting them is a well-known technique, and hence description thereof is omitted. The CPU 201 can set a learning end condition in this step.

In the step S504, the CPU 201 learns the hiding model, and then the process proceeds to step S505. The output data from the existing model recorded in the recording unit 206 in the step S502 is used as input data for hiding, which is used to train the hiding model. It should be noted that the training is performed using the method described above with reference to FIG. 4.

In the step S505, the CPU 201 determines whether or not the learning end condition has been met. This determination can be made using either the learning end condition set in advance in the step S503 or a learning end condition input by the user via the operating unit 205. It should be noted that examples of the learning end condition set in advance include the condition that a predetermined number of epochs has been run, the condition that the loss has become equal to or smaller than a predetermined value, and the condition that a certain number or more of zeros is not included, but the learning end condition set in advance is not limited to these conditions.

Upon determining that the learning end condition has been met (YES in the step S504), the CPU 201 ends the training to end the present process. On the other hand, when the CPU 201 determines that the learning end condition has not been met (NO in the step S505), the process returns to the step S503.

A description will now be given of the flowchart in FIG. 5B illustrating the learning process for the decryption model according to the first embodiment, which is carried out by the learning apparatus 200. This learning process is implemented by a computer program stored in the recording unit 206 being loaded into the memory 202 and read out and executed by the CPU 201 when the power to the learning apparatus 200 is on.

In step S511, the CPU 201 carries out the same process as in the step S501, and then the process proceeds to step S512.

In the step S512, the CPU 201 carries out the same process as in the step S502, and then the process proceeds to step S513. Output data held in the memory 202 in the step S511, however, is used as input data for hiding in step S513, which will be described later, and training data in step S516, which will be described later.

In the step S513, the CPU 201 inputs input data for hiding recorded in the recording unit 206 in the step S512 to the hiding model generated in the process in FIG. 5A and carries out an inference process. The CPU 201 holds output data from the hiding model in the memory 202, and then the process proceeds to step S514.

In the step S514, the CPU 201 records the output data from the hiding model in the memory 202, which was held in the memory 202 in the step S513, as input data for decryption in the recording unit 206, and then the process proceeds to step S515.

In the step S515, the CPU 201 obtains a decryption model (third inference model) from the nonvolatile memory 209 and makes pre-learning settings for the decryption model as with the step S503 and sets hyperparameters therefor and others before training, followed by the process proceeding to the step S516.

In the step S516, the CPU 201 trains the decryption model, and the process then proceeds to step S517. Specifically, the CPU 201 inputs the input data for decryption, which was recorded in the recording unit 206 in the step S514, to the decryption model, and trains the decryption model such that the difference between an inference result and the training data recorded in the recording unit 206 in the step S512 can be small. It should be noted that the training is performed using the method described above with reference to FIG. 4.

In the step S517, the CPU 201 determines whether or not a learning end condition has been met. This determination can be made using either a learning end condition set in advance in the step S515 or a learning end condition input by the user from the operating unit 205. It should be noted that examples of the learning end condition set in advance include the condition that a predetermined number of epochs has been run, the condition that the loss has become equal to or smaller than a predetermined value, and the condition that a certain number or more of zeros is not included, but the learning end condition set in advance is not limited to these conditions.

Upon determining that the learning end condition has been met (YES in the step S517), the CPU 201 ends the learning to end the present process. On the other hand, when the CPU 201 determines that the learning end condition has not been met (NO in the step S517), the process returns to the step S515.

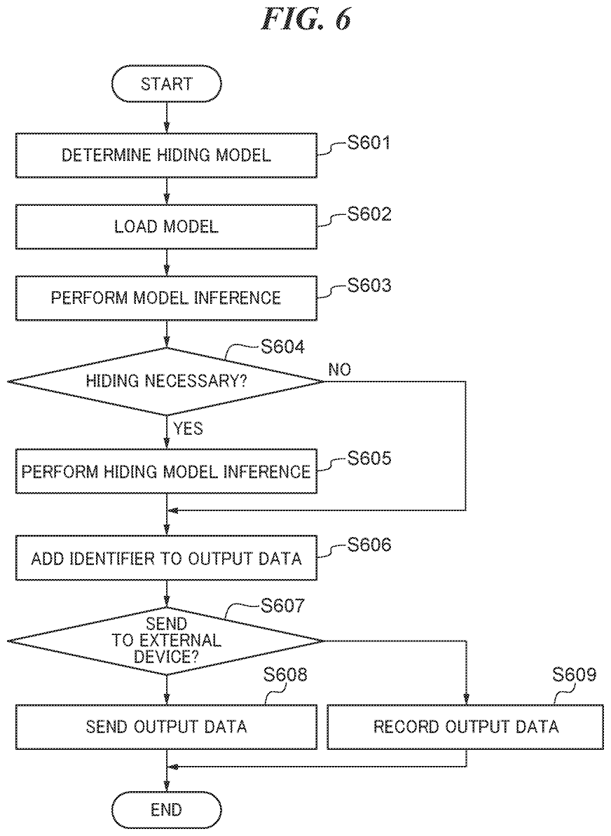

FIG. 6 is a flowchart illustrating an inference process according to the first embodiment, which is carried out by the inference apparatus 300. This inference process is implemented by a computer program stored in the recording unit 319 being loaded into the memory 302 and read out and executed by the CPU 301 when the power to the inference apparatus 300 is on.

In step S601, the CPU 301 determines which hiding model will be used among hiding models corresponding to existing models in the nonvolatile memory 303, and then the process proceeds to step S602. Specifically, according to an existing model selected by the user, the CPU 301 narrows down the hiding models to a hiding model to be used, and obtains it from the nonvolatile memory 303. For example, when an output result from the selected existing model applies to a case where it is recorded in the recording unit 319 (recording medium), the CPU 201 does not use any hiding model or selects a small-scale hiding model. When an output result from the selected existing model applies to a case where an inference result from the inference apparatus 300 is sent to an output destination across a wired serial cable via the communication unit 316, the CPU 201 does not use any hiding model or selects a small-scale hiding model. When an output result from the selected existing model applies to a case where it does not include any personal information, the CPU 201 does not use any hiding model or selects a small-scale hiding model. When an output result from the selected existing model is to be sent to an external device through the communication unit 316 over a wireless or wired network, the CPU 201 selects a hiding model according to the security level of communication. Namely, the lower the security level, the larger the scale of hiding by a hiding model to be selected. Moreover, when an output result from the selected existing model is passed through a hiding model, there is an unavoidable error between the processing result of decryption and the output result from the existing model, and hence if the error is not acceptable, a hiding model which performs hiding on a small scale is selected. It should be noted that the external device is, for example, the information processing apparats 100.

In step S602, the CPU 301 loads a model selected by a user among the existing models existing in the nonvolatile memory 303, information indicating the configuration of a network model of the hiding model determined in the step S601, and dictionary data from the nonvolatile memory 303 into the memory 302. The process then proceeds to step S603. It should be noted that this step can be skipped if the information indicating the configuration of the network model and the dictionary data are loaded from the nonvolatile memory 303.

In step S601, the CPU 301 controls the neural network processing unit 302 to carry out the inference process using the existing model loaded into the memory 302. The CPU 301 obtains output data from the existing model and holds the output data in the memory 302. The process then proceeds to step S604.

In the step S604, the CPU 301 determines whether or not it is necessary to hide the output data from the existing model. This determination is made based on the hiding model determination result obtained in the step S601. When the CPU 301 determines that it is necessary to hide the output data from the existing model (YES in the step S604), the process then proceeds to step S605. On the other hand, when the CPU 301 determines that it is unnecessary to hide the output data from the existing model (NO in the step S604), the process then proceeds to step S606.

In the step S605, the CPU 301 runs the hiding model selected in the step S601 by controlling the neural network processing unit 305, and outputs an inference result. Specifically, the CPU 301 inputs the output data from the existing model, which was stored in the memory 302 in the step S603, as input data to the hiding model, which was loaded into the memory 302 in the step S602. After that, the CPU 301 holds output data (first inference result) from the hiding model in the memory 302, and then the process proceeds to the step S606.

In the step S606, the CPU 301 adds an identifier to the output data from the hiding model held in the memory 302 in the step S605. It should be noted that in the step S606, in the case where it was determined in the step S604 that hiding was unnecessary, the identifier is added to the output data (second inference result) from the existing model held in the memory 302 in the step S603. The identifier (identification information) is information identifying whether output data held in the memory 302 is output data from the hiding model or output data from the existing model. In the first embodiment, the type of the model (the hiding model or the existing model) that has output the output data can be identified with the identifier. The CUP 301 holds the output data from the hiding model (or the output data from the existing model), to which the identifier is added, in the memory 302, and the process then proceeds to step S607. In the following description, the data held in the memory 302 in the step S606 will be referred to merely as the output data.

In the step S607, the CPU 301 determines whether or not to send the output data held in the memory 302 in the step S606 to an external device. When the CPU 301 determines that the output data will be sent to the external device (YES in the step S607), the process proceeds to step S608, in which the CPU 301 sends the output data to the destination via the communication unit 316 and then ends the present process. On the other hand, when the CPU 301 determines that the output data will not be sent to the external device (NO in the step S607), the CPU 301 records the output data in the recording unit 319 and then ends the present process. It should be noted that upon determining that the output data will be sent to the external device, the CPU 301 may record the output data to the external device and also record the output data in the recording unit 319 at the same time.

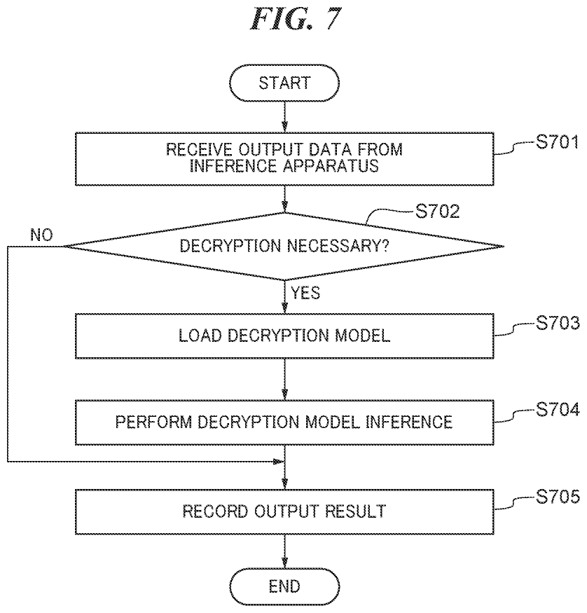

FIG. 7 is a flowchart illustrating a decryption process according to the first embodiment, which is carried out by the information processing apparatus 100. This decryption process is implemented by a computer program stored in the recording unit 106 being loaded into the memory 102 and read out and executed by the CPU 101 when the power to the information processing apparatus 100 is on. It should be noted that the configuration of the information processing apparatus 100 is the same as that of the learning apparatus 200.

In step S701, the CPU 101 controls the communication unit 107 to receive the output data sent from the inference apparatus 300 in the step S608 in FIG. 6, and holds the output data in the memory 102, followed by the process proceeding to step S702.

In the step S702, the CPU 101 determines whether or not decryption is necessary based on an identifier included in the output data held in the memory 102 in the step S701. When the CPU 101 determines that decryption is necessary (YES in the step S702), the process proceeds to step S703. On the other hand, when the CPU 101 determines that decryption is not necessary (NO in the step S702), the process proceeds to step S705.

In the step S703, the CPU 101 selects a decryption model corresponding to a hiding model identified from the identifier included in the output data held in the memory 102 in the step S701. Then, the CPU 101 loads network information on the decryption model from and dictionary data recorded in the recording unit 106 and records these loaded data in the memory 102. The process then proceeds to the step S703.

In the step S704, the CPU 101 causes the neural network processing unit 108 to carry out an inference process. Specifically, the CPU 101 constructs the decryption model using the network information and the dictionary data held in the memory 102 in the step S703, and uses the output data received in the step S701 as input data for the decryption model. The CPU 101 holds the result of the inference process in the memory 102, and the process proceeds to the step S705.

In the step S705, the CPU 101 records the result of the inference process held in the memory 102 in the step S704 in the recording unit 106 and then ends the present process.

According to the first embodiment described above, even if there is no processing unit exclusively for encryption, it is possible to hide an existing neural network processing result. It should be noted that although in the first embodiment described above, a hiding model is added to an existing model, but learning process may be performed such that a hiding model is generated such as to include an existing model.

### Second Embodiment

In the learning method according to the first embodiment of the present invention, models are generated by separately training a hiding model and a decryption model. On the other hand, in a learning method according to a second embodiment, a hiding model and a decryption model are trained together and divided later.

It should be noted that in the description of the second embodiment, the same features as those in the first embodiment are denoted by the same reference numerals, and description thereof is omitted.

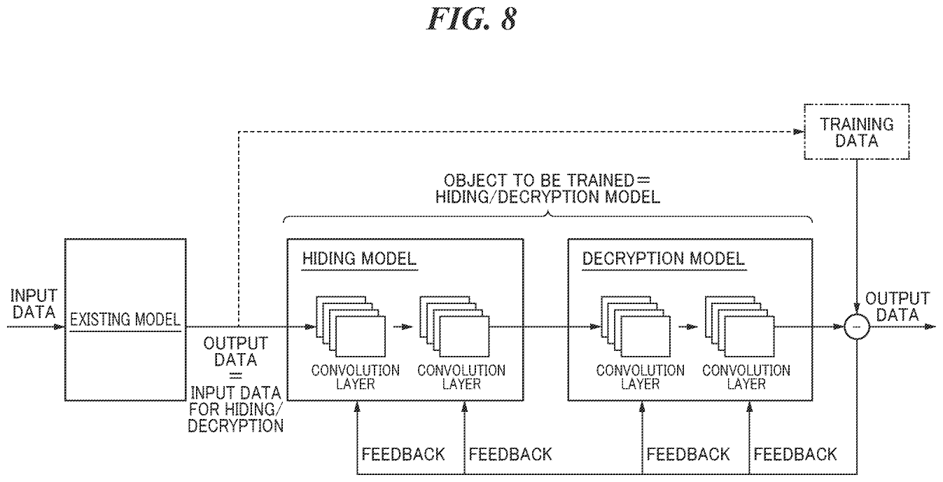

FIG. 8 is a view illustrating the flow of data in a learning process according to the second embodiment, which is carried out by the learning apparatus 200. It should be noted that the learning process for a hiding model and a decryption model is carried out in the neural network processing unit 208 by the CPU 201 controlling a training program.

As shown in FIG. 8, the learning process for a hiding model and the learning process for a decryption model are carried out at the same time in the learning apparatus 200. Namely, an object to be trained by the learning apparatus 200 according to the second embodiment is a hiding/decryption model (fourth inference model) that is comprised of at least two layers and hides output data from an existing model and then decrypts the hidden output data.

Input data is input to the existing model and subjected to predetermined neural network processing, and as a result, output data is output. At this time, the output data from the existing model is used as input data (hiding/decryption input data) for training the hiding/decryption model. Namely, when the output data from the existing model is input to the hiding/decryption model, the output data is subjected to the neural network processing programmed in advance. As a result, output data from the hiding/decryption model is obtained. It should be noted that in the learning, not the output data from the existing model but input data for the existing model can be used to train the hiding/decryption model in a form that includes the existing model.

Next, the output data from the hiding/decryption model and training data, which is the same data as input data for hiding/decryption prepared in advance, are compared with each other, and based on the result of the comparison, feedback is given to each layer of the hiding/decryption model. As a result, parameters in the layers of the hiding/decryption model are optimized so as to make that the difference between the output data from the hiding/decryption model and the training data small. The parameters in the layers of the hiding/decryption model are optimized using a learning algorithm for neural networks such as the back propagation method. It should be noted that the learning algorithm is a well-known technique, and hence description thereof is omitted from the description of the second embodiment as well.

The learning apparatus 200 divides the hiding/decryption model generated by the learning method described above into a processing unit for hiding and a processing unit for decryption. The processing unit for hiding includes a processing layer comprised of at least one layer for hiding output data from the existing model. The processing unit for decryption includes a processing layer comprised of at least one layer for decrypting output data from the processing unit for hiding and producing an output equivalent to output data from the first inference model described above.

The hiding/decryption model is divided into the processing unit for hiding and the processing unit for decryption using a method in which output from the processing unit for hiding is considered as one output and input to the processing unit for decryption is considered as one input in the case where the layer structure does not branch. In the case where the layer has multilayer structure split into N branches, the hiding/decryption model is divided using a method in which output from the processing unit for hiding is considered as N output and input to the processing unit for decryption is considered as N input. In order to increase the strength of hiding, the learning apparatus 200 divides the hiding/decryption model such that the scale of the processing unit for hiding is larger than that of the processing unit for decryption. On the other hand, to increase the processing speed of encryption (reduce the inference processing time), the learning apparatus 200 divides the hiding/decryption model such that the scale of the processing unit for hiding is smaller than that of the processing unit for decryption (such that the strength of hiding is decreased). The processing unit for hiding obtained by dividing the hiding/decryption model as described above is generated as an independent hiding model, and a neural network layer structure and dictionary data are extracted as independent information to generate a file. Likewise, the processing unit for decryption is generated as an independent decryption model. It should be noted that in the case where the hiding/decryption model are trained in a form that includes the existing model, a predetermined model can be included in the processing unit for hiding.

As a result of the training described above, output data equivalent to output data form the existing model can be output from the decryption model. It should be noted that although in the above description, the hiding/decryption model is a learning model of a neural network, other learning methods can be used. Moreover, although in the embodiment described above, the training data is used in the learning process, other learning processes such as reinforcement learning can be used.

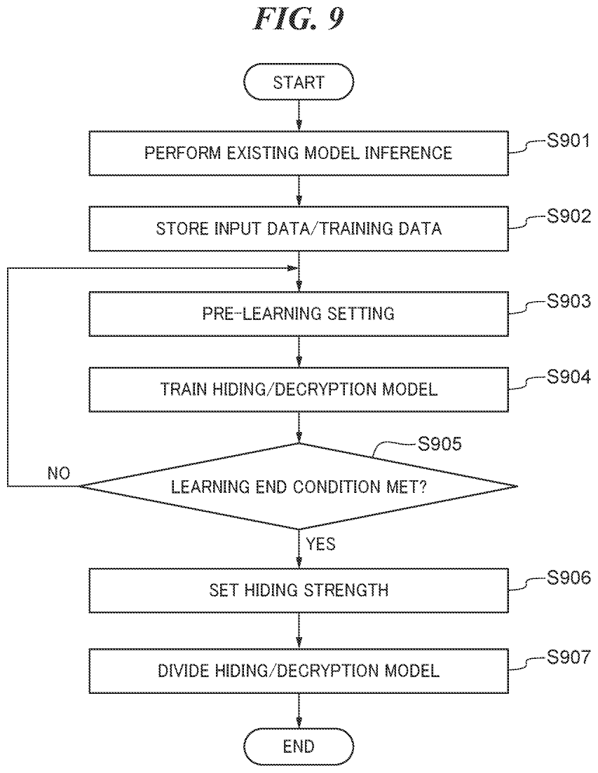

FIG. 9 is a flowchart illustrating a learning process for the hiding/decryption model according to the second embodiment, which is carried out by the learning apparatus 200.

This learning process is implemented by a computer program stored in the recording unit 206 being loaded into the memory 202 and read out and executed by the CPU 201 when the power to the learning apparatus 200 is on.

In step S901, as with the step S501, the CPU 201 carries out an inference process on an existing model, which performs predetermined neural network processing, and holds output data obtained from the existing model in the memory 202. The process then proceeds to step S902.

In the step S902, the CPU 201 stores the output data obtained from the existing model, which was held in the memory 202 in the step S901, in the recording unit 206, and then the process proceeds to step S903. It should be noted that the output data obtained from the existing model in the memory 202 serves as not only input data for hiding/decryption but also training data as described earlier with reference to FIG. 8.

In the step S903, as with the step S503, the CPU 201 obtains a hiding/decryption model from the nonvolatile memory 209 and makes pre-learning settings for the hiding/decryption model, followed by the process proceeding to step S904. As with the step S503, the CPU 201 may set a learning end condition in this step.

In the step S904, the CPU 201 trains the hiding/decryption model, followed by the process proceeding to step S905. The output data from the existing model recorded in the recording unit 206 in the step S902 is used as input data for hiding/decryption used for the training. It should be noted that the training is performed using the method described above with reference to FIG. 8.

In the step S905, as with the step S505, the CPU 201 determines whether or not the learning end condition has been met. This determination can be made using either the learning end condition set in advance in the step S903 or a learning end condition input by the user through the operating unit 205. It should be noted that examples of the learning end condition set in advance include the condition that a predetermined number of epochs has been run, the condition that the loss has become equal to or smaller than a predetermined value, and the condition that a certain number or more of zeros is not included, but the learning end condition set in advance is not limited to these conditions.

Upon determining that the learning end condition has been met (YES in the step S905), the CPU 201 ends the training, followed the process proceeding to step S906. On the other hand, when the CPU 201 determines that the learning end condition has not been met (NO in the step S905), the process returns to the step S903.

In the step S906, the CPU 201 sets the strength of hiding for the trained model as the strength input by the user via the operating unit 205, followed by the process proceeding to step S907.

In the step S907, the CPU 201 generates a hiding model and a decryption model by dividing the hiding/decryption model according to the strength of hiding, which was set in the step S906, using the method described earlier with reference to FIG. 8, and then ends the present process.

According to the second embodiment described above, a hiding/decryption model is trained and divided into appropriate scales according to the strength of hiding to generate a hiding model and a decryption model. The hiding model and the decryption model are thus trained at the same time.

Although the embodiments have been described in detail, the present invention should not be limited to specific embodiments, but various modifications and alterations can be made without departing from the spirit of the prevent invention. All or some of the component elements in the embodiments described above may be used in combination as appropriate.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The processors or circuits may include a central processing unit (CPU), a micro processing unit (MPU), a graphics processing unit (GPU), an application specific integrated circuit (ASIC), and a field-programmable gate array (FPGA). The processors or circuits may also include a digital signal processor (DSP), a data flow processor (DFP), or a neural processing unit (NPU).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-075014, filed Apr. 28, 2022, which is hereby incorporated by reference wherein in its entirety.

What is claimed is:

1. A learning apparatus for use in a hiding process using a neural network, comprising:
at least one processor configured to perform operations of:
obtaining output data from a first inference model that has been trained and performs predetermined processing on input data;
obtaining a second inference model including a processing layer for hiding comprising at least one layer for hiding the output data; and
using the output data from the first inference model as input data to train the second inference model.

2. The learning apparatus according to claim 1, wherein the at least one processor is configured to perform further operations of:
obtaining a third inference model including a processing layer for decryption comprising at least one layer for decrypting output data from the second inference model; and
using the output data from the second inference model as input data and using the output data from the first inference model as training data to train the third inference model.

3. A learning apparatus for use in a hiding process using a neural network, comprising:
at least one processor configured to perform operations of:
obtaining output data from a first inference model that has been trained and performs predetermined processing on input data; and
obtaining a fourth inference model comprising at least two layers that hide the output data and then decrypt the hidden output data,
wherein the fourth inference model comprises a processing unit for hiding including a processing layer comprising at least one layer for hiding the output data from the first inference model, and a processing unit for decryption including a processing layer for decryption comprising at least one layer for decrypting the output data from the processing unit for hiding.

4. The learning apparatus according to claim 3, wherein the at least one processor is configured to perform further operations of:
dividing the fourth inference model into a second inference model as the processing unit for hiding and a third inference model as the processing unit for decryption.

5. The learning apparatus according to claim 4, wherein the at least one processor is configured to perform further operations of:
setting a scale of the processing unit for hiding and a scale of the processing unit for decryption in the fourth inference model according to a strength of hiding and an inference processing time period in the second inference model.

6. The learning apparatus according to claim 1, wherein the at least one processor is configured to perform further operations of:
when training the second inference model using the output data from the obtained first inference model as input data, training the second inference model using training data comprising values that do not include a predetermined number of zeros or more.

7. The learning apparatus according to claim 1, wherein the second inference model comprises a plurality of models corresponding to the first inference model.

8. The learning apparatus according to claim 1, wherein the third inference model includes the first inference model.

9. The learning apparatus according to claim 3, wherein the at least one processor is configured to perform further operations of:
training the fourth inference model using the output data from the first inference model as input data and training data.

10. An inference apparatus for use in a hiding process using a neural network, comprising:
at least one processor configured to perform operations of:
executing a first inference model that has been trained and performs predetermined processing on input data, and obtaining output data from the first inference model;
obtaining a second inference model that has been trained and includes a processing layer for hiding comprising at least one layer for hiding the output data; and
using the output data from the first inference model as input data to run the second inference model and outputting output data from the second inference model as an inference result.

11. The inference apparatus according to claim 10, wherein the at least one processor is configured to perform further operations of:
determining whether or not hiding by the second inference model is necessary; and
in a case where it is determined that the hiding is unnecessary, outputting the output data from the first inference model as an inference result without running the second inference model.

12. The inference apparatus according to claim 11, wherein the at least one processor is configured to perform further operations of:
determining that hiding by the second inference model is unnecessary when at least one of the following cases apply: a case where the output data from the first inference model is recorded on a recording medium which the inference apparatus has, a case where the output data from the first inference model includes no personal information, and a case where an output destination of the inference result from the inference apparatus is connected by wire.

13. The inference apparatus according to claim 11, wherein the at least one processor is configured to perform further operations of:
determining that hiding by the second inference model is necessary in a case where output data from the inference apparatus is to be output to an external device using a network line.

14. The inference apparatus according to claim 11, wherein the at least one processor is configured to perform further operations of:
adding identification information, which indicates whether the inference result from the inference apparatus is a first inference result comprising the output data from the second inference model or a second inference result comprising the output data from the first inference model, to the inference result from the inference apparatus.

15. The inference apparatus according to claim 14, wherein the at least one processor is configured to perform further operations of:
when obtaining the second inference model, selecting the second inference model from a plurality of inference models according to a security level of communication means for use in outputting the inference result.

16. The inference apparatus according to claim 15, wherein the identification information includes information identifying which one of the inference models is the second inference model in a case where the inference result from the inference apparatus is the first inference result.

17. An inference system for use in a hiding process using a neural network, comprising a learning apparatus, a first inference apparatus, and a second inference apparatus,
wherein the learning apparatus comprises at least one processor configured to perform operations of:
obtaining output data from a first inference model that has been trained and performs predetermined processing on input data;
obtaining a second inference model including a processing layer for hiding comprising at least one layer for hiding the output data;
using the output data from the first inference model as input data to train the second inference model;
obtaining a third inference model including a processing layer for decryption comprising at least one layer for decrypting output data from the second inference model; and
using the output data from the second inference model as input data and using the output data from the first inference model as training data to train the third inference model,
wherein the first inference apparatus comprises at least one processor configured to perform operations of:
running a first inference model that has been trained and performs predetermined processing on input data, and obtaining output data from the first inference model;
obtaining the trained second inference model from the learning apparatus;
using the obtained output data from the first inference model as input data to run the obtained second inference model and outputting output data from the second inference model; and
sending the output data from the second inference model to the second inference apparatus,
wherein the second inference apparatus comprises at least one processor configured to perform operations of:
receiving the output data from the second inference model from the first inference apparatus;
obtaining the trained third inference model from the learning apparatus; and
using the output data received from the second inference model as input data to run the obtained third inference model and decrypting the output data from the second inference model.

18. The inference system according to claim 17, wherein the at least one processor of the first inference apparatus is configured to perform further operations of:
when obtaining the trained second inference model from the learning apparatus, selecting the second inference model from a plurality of inference models according to a security level.

19. A control method for a learning apparatus, comprising:
obtaining output data from a first inference model that has been trained and performs predetermined processing on input data;
obtaining a second inference model including a processing layer for hiding comprising at least one layer for hiding the output data; and
using the output data from the first inference model as input data to train the second inference model.

20. A control method for an inference apparatus, comprising:
running a first inference model that has been trained and performs predetermined processing on input data, and obtaining output data from the first inference model;
obtaining a second inference model that has been trained and includes a processing layer for hiding comprising at least one layer for hiding the output data; and
using the output data from the first inference model as input data to run the second inference model and outputting output data from the second inference model as an inference result.

21. A non-transitory storage medium storing a program for causing a computer to execute a control method for a learning apparatus, the control method for the learning apparatus comprising:
obtaining output data from a first inference model that has been trained and performs predetermined processing on input data;
obtaining a second inference model including a processing layer for hiding comprising at least one layer for hiding the output data; and
using the output data from the first inference model as input data to train the second inference model.

22. A non-transitory storage medium storing a program for causing a computer to execute a control method for an inference apparatus, the control method for the inference apparatus comprising:
running a first inference model that has been trained and performs predetermined processing on input data, and obtaining output data from the first inference model;
obtaining a second inference model that has been trained and includes a processing layer for hiding comprising at least one layer for hiding the output data; and
using the output data from the first inference model as input data to run the second inference model and outputting output data from the second inference model as an inference result.
